(19) United States
(12) Patent Application Publication
(10) Pub. No.: US 2021/0329908 A1
(43) Pub. Date: Oct. 28, 2021

(54) Drop and Stop

(71) Applicants: Barry Corl, Mill Hall, PA (US); Jacqueline Corl, Mill Hall, PA (US); Thomas Soo, Bellefonte, PA (US)

(72) Inventors: Barry Corl, Mill Hall, PA (US); Jacqueline Corl, Mill Hall, PA (US); Thomas Soo, Bellefonte, PA (US)

(21) Appl. No.: 17/238,339

(22) Filed: Apr. 23, 2021

Related U.S. Application Data
(60) Provisional application No. 63/014,328, filed on Apr. 23, 2020.

(51) Int. Cl. A01M 31/02

(52) U.S. Cl. CPC A01M 31/02

(57) ABSTRACT

Aspects disclosed herein include a safety mechanism which may be installed with an existing tree stand or be incorporated into the design of a tree stand or other platform device. A safety strut may be installed below a platform and connect with a fibrous material, such as a tree. The safety strut may use such a connection and/or the weight of a user to secure its position. Adjustments may be made to the height of the safety strut.

### CROSS REFERENCE

This application claims the benefit of U.S. Provisional Application No. 63/014,328, filed Apr. 23, 2020, which application is incorporated herein by reference.

### BACKGROUND OF THE INVENTION

Tree stands are prefabricated detachable structures generally used for wildlife observation and game hunting. Specifically, the tree stand is intended to support the user at an elevated height while the structure is bound to the side of the tree trunk. “Tree Stands” have two principal components, a vertical frame which is secured to the tree trunk with chains or cables and a horizontal standing platform. The back edge of the platform is usually hinge mounted to the bottom of the vertical frame for compact storage and to make it easier for transport. To maintain a horizontal position for the standing platform a pair of chains or cables is attached to the front edge of the platform and top edge of the vertical frame and most tree stands come outfitted with a seat and safety rail. Over time the chains, cables, or their attachments can fail due to adverse weather conditions, overuse, or misuse. Should this happen the standing platform would collapse, and the user would be in a life-or-death situation. By installing this safety device, one which could be retrofitted to fit existing tree stands or incorporated onto new tree stands, this potentially dangerous situation could be mitigated.

### SUMMARY OF THE INVENTION

Aspects disclosed herein include a safety mechanism which may be installed with an existing tree stand or be incorporated into the design of a tree stand or other platform device. A safety strut may be installed below a platform and connect with a fibrous material, such as a tree. The safety strut may use such a connection and/or the weight of a user to secure its position. Adjustments may be made to the height of the safety strut.

The general description and the following detailed description are exemplary and explanatory only and are not restrictive of the invention, as defined in the appended claims. Other aspects of the present invention will be apparent to those skilled in the art in view of the detailed description of the invention as provided herein.

### BRIEF DESCRIPTION OF THE DRAWINGS

The novel features of the invention are set forth with particularity in the following statements. A complete description of the features and advantages of the invention will be included in the detailed description.

FIG. 1 is an exemplary embodiment of the safety strut device from a side view depicting: safety strut addition, adjustable connecting mechanism linked to a platform on first end, metal teeth at a second end, to lean into the point of contact with the fibrous material after release.

FIG. 2 is an exemplary embodiment of the adjustable and flexible chain design depicting: metal chain connecting a standing platform with a second end of a safety strut.

FIG. 3 is an exemplary embodiment of the adjustable and flexible chain design depicting: a metal platform with supporting restraints connected to a fibrous material and a platform, additional restraints connected from the front end of the platform to the fibrous material and the platform.

FIG. 4 is an exemplary photograph of invention depicting: platform with restraints connected to a fibrous material and a tree stand, adjustable and flexible chain connecting a bottom of the platform and a toothed component of the safety strut, and the safety strut attachment connected from the front end of the platform to a point of contact on the tree.

FIG. 5 is an exemplary embodiment of a safety strut device from a side view connected to a fibrous material.

FIG. 6 is an exemplary embodiment of a safety strut device from a top view depicting a safety strut connected via a U-Bolt.

FIG. 7 is an exemplary embodiment of a safety strut device from a side view.

### DETAILED DESCRIPTION OF THE INVENTION

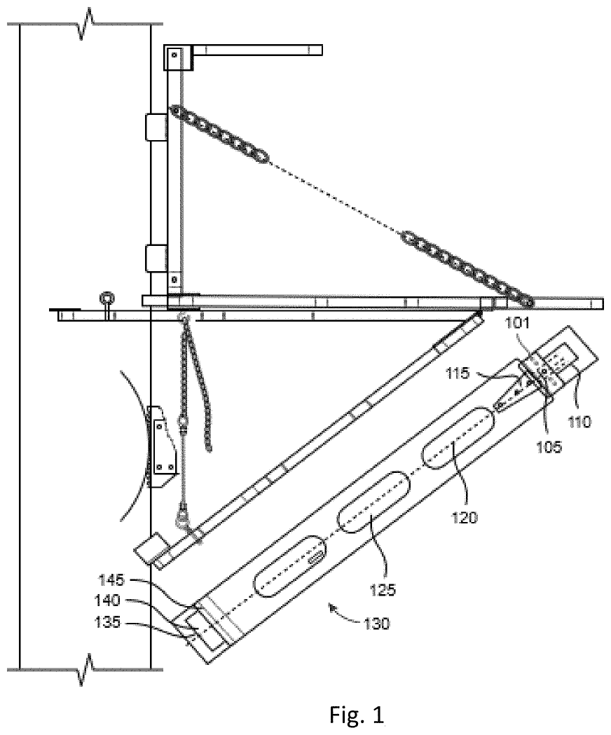

FIGS. 1-3 depict some non-limiting embodiments of a safety strut with adjustable connector and platform and components thereof. In some non-limiting embodiments, the safety strut acts as an attachment to a lower section of a tree stand to provide additional support in the event that the secured apparatus of the tree stand fails. The safety strut interacts with the bottom of a tree stand platform in some non-limiting embodiments and/or connects to a platform separate and secured below the tree stand platform in some non-limiting embodiments. In some non-limiting embodiments, the safety strut may be released from the bottom of the platform in the event of tree stand security failure and/or the safety strut may be secured to platform and a fibrous material prior to failure of the tree stand security restraints.

In some non-limiting embodiments, such as the example found in FIG. 1, the top end (105) of the safety strut (130) connects to a movable joint (100) in contact with the platform secured by said joint.

In some non-limiting embodiments, a top end of a safety strut (100, 105, 110) may be connected to a platform on the upward facing side of the top end of the safety strut. In some non-limiting embodiments, the top end of the safety strut may be connected to the platform on a first end. In some non-limiting embodiments, two or more metal plates (100, 110) may be connected on a first end of the safety strut. In some non-limiting embodiments, the metal plates may be used to fit onto an upward facing section to create a moveable joint for upward and downward movement of the safety strut.

In some non-limiting embodiments, a connecting joint may be secured to the safety strut with an additional metal plate to create a moveable joint (115) fastened to the safety strut. In some non-limiting embodiments, the two or more metal plates may be formatted to fit a design where a castellated design (120, 125) of the safety strut (130) exists. In some non-limiting embodiments, the castellated design (120, 125) may be used to strengthen the safety strut (130). The three ellipses of the castellated design (120, 125) may be of varying widths, such as non-limiting examples, 2, 3, 4, 5, 6, or any like inches in width, and the safety strut (130) may be of varying lengths, such as in non-limiting examples, about 3, 4, 5, 6, or 7 inches in width. In some non-limiting embodiments, the safety strut (130) may be made of varying materials, such as in non-limiting examples, metal, aluminum tubing, plastic, concrete, stone, or wood.

In some non-limiting embodiments, a metal plate may be used to secure a serrated, spiked, jagged, notched, or toothed component (135) to a bottom end of the safety strut that contacts a fibrous material. The fibrous material may be of varying materials, such as in non-limiting examples, a tree, or a pole. In some non-limiting embodiments, the metal plate may be used to secure a serrated, spiked, jagged, notched, or toothed component to a second end of the safety strut that contacts the tree. In some non-limiting embodiments, the metal plate (140) may include holes (145) that may be secured with bolts or screws into the safety strut (130). In some non-limiting embodiments, the metal plate (140) may be of varying lengths, such as in non-limiting examples, about 1, 2, 3, 4, 5, or 6 inches in width and about 3, 4, 5, 6, 7, or 8 inches in length.

In some non-limiting embodiments, the safety strut (130) depicted in FIG. 1, may be rectangular in shape. In some non-limiting embodiments, the safety strut (130) may be of varying lengths, such as in non-limiting examples, about 15, 20, 25, 30, 35, 40, 45, or 50 inches in length from end to end. In some non-limiting embodiments, all four corners of the safety strut (130) may be flush at varying angles, such as in non-limiting examples, about 60, 65, 70, 75, 80, 85, 90, or 95-degree angles.

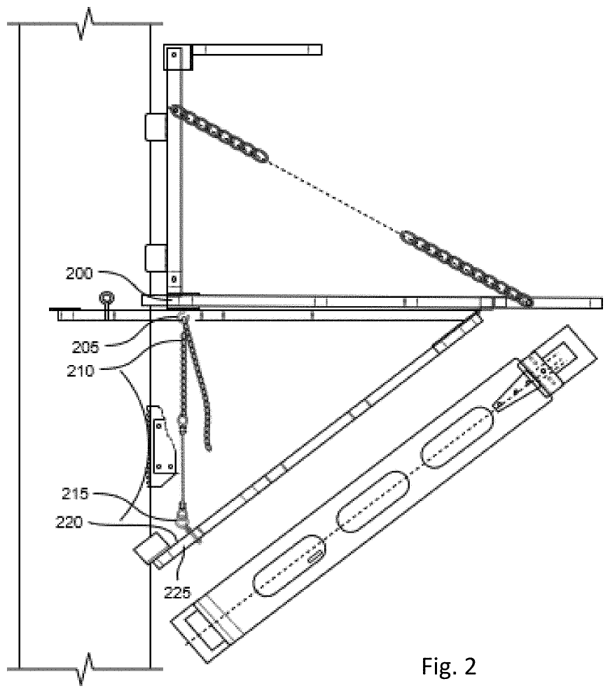

In some non-limiting embodiments, such as the example found in FIG. 2, some non-limiting embodiments may include a connector (210) that is used to connect the section of the platform (200) in contact with the fibrous material and restraints or attaches to the loop (215) on the second end (220) of the safety strut (225) that contains or includes serrated, spiked, jagged, notched, or toothed edges. In some non-limiting embodiments, a hook (205) may be used to latch onto a portion of the connector (210) to adjust to the desired height. In some non-limiting embodiments, the connector (210) can latch or fasten onto the hook (205), securing the safety strut (130) as it leans or connects into the fibrous material. In some non-limiting embodiments, the connector (210) connects to the safety strut (225) on the second end (220) with a loop (215). In some non-limiting embodiments, the connector (210) may be comprised of a varying material, such as in non-limiting examples, a chain, a bungie cord, a string, a rope, or any combination.

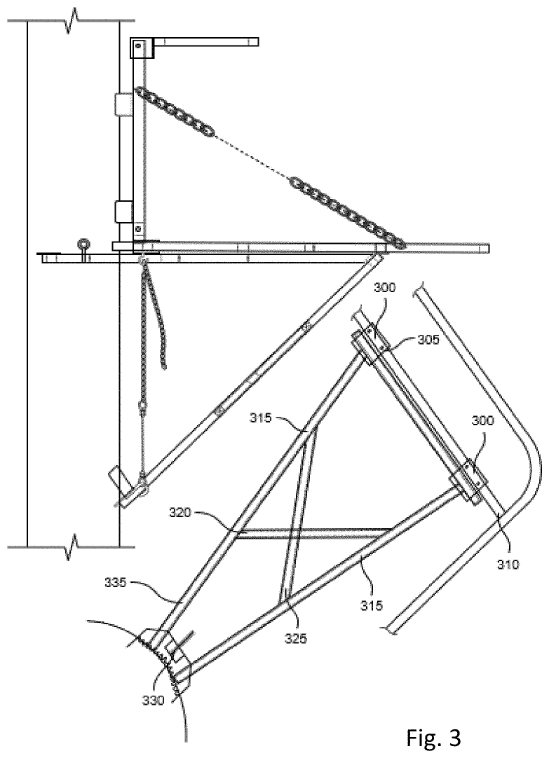

In some non-limiting embodiments, such as the example found in FIG. 3, a first end of safety strut (305) can connect to a platform (310) with one or more movable joints (300) that allow the safety strut (335) to be adjusted using the connector (330). In some non-limiting embodiments, the metal plate connecting the movable joint to the top section of safety strut may be of varying lengths, such as in non-limiting examples, 14, 15, 16, 17, 18, 19, or 20 inches.

In some non-limiting embodiments, two intersecting bars (315) can connect from a moveable joint (300) that meets the top end or first end (305) of the safety strut (335) and the restraint that connects with the fibrous material. In some non-limiting embodiments, two or more reinforcing bars (320, 325) may be used to provide additional stability when attached to the platform (310) and to distribute weight.

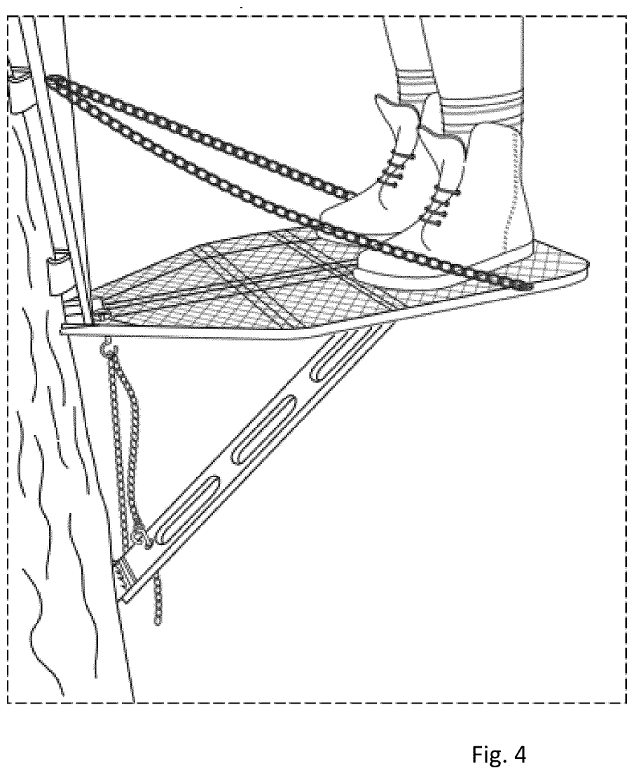

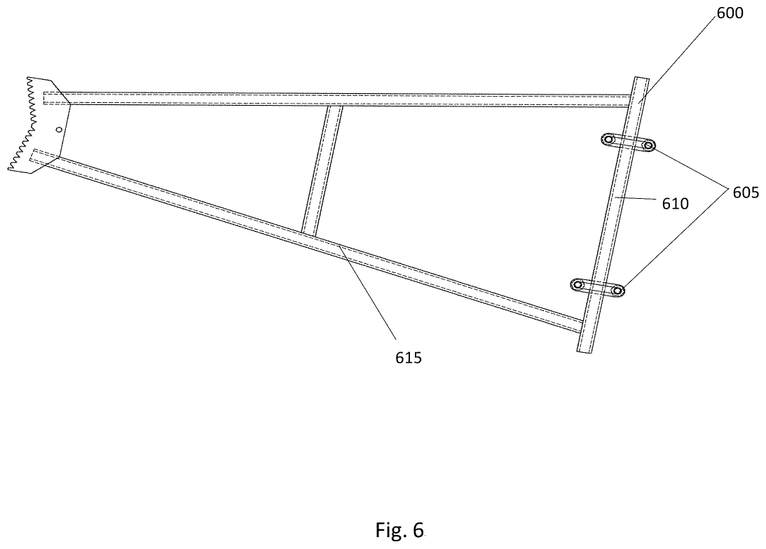

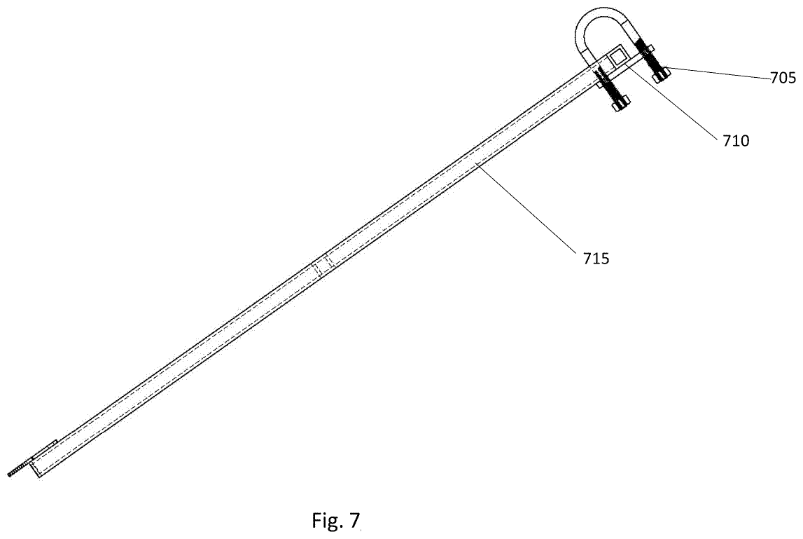

As exemplified in FIG. 4, FIG. 4 depicts a photograph of one embodiment of the design using a safety strut as described in FIGS. 1-3 and 5-7.

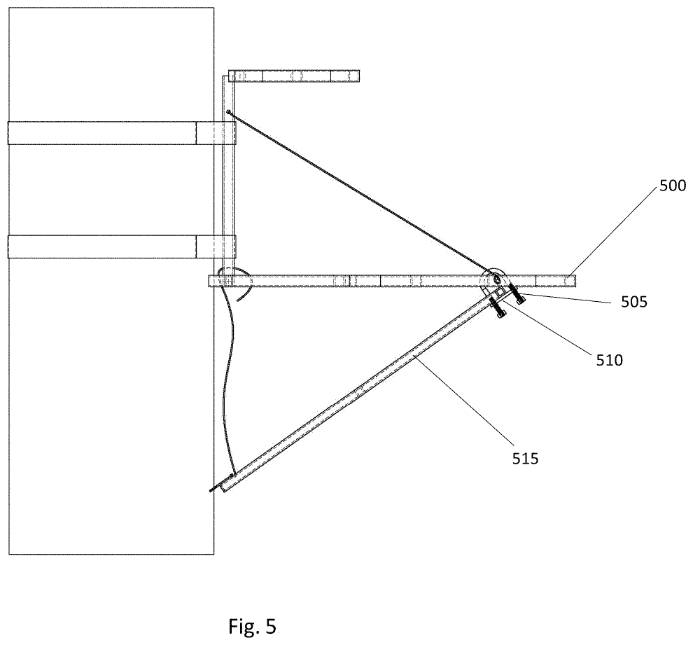

In some non-limiting embodiments, such as the non-limiting examples found in FIGS. 5, 6, and 7, the first end (510, 610, 710) of the safety strut (515, 615, 715) can connect to a platform (500, 600) with one or more U-bolts (505, 605, 705).

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A safety strut device for a tree stand comprising:
a safety strut, wherein said safety strut comprises a first end that contacts a platform and a second end that contacts a fibrous material; and
a connector, wherein said connector comprises a mechanism for adjusting the space between the platform and the second end of the safety strut.

2. The safety strut device of claim 1, wherein the first end is fastened to the platform via a U-bolt.

3. The safety strut device of claim 1, wherein the first end is fastened to the platform via a moveable joint.

4. The safety strut device in claim 1, wherein the first end in contact with the platform comprises a movable joint.

5. The safety strut device of claim 1, wherein the second end comprises a metal plate, wherein the metal plate contacts the fibrous material via a toothed component.

6. The safety strut device of claim 1, wherein the safety strut is made of metal.

7. The safety strut device of claim 1, wherein the safety strut is made of aluminum tubing.

8. The safety strut device of claim 1, wherein the connector is connected to the platform with a hook.

9. The safety strut device of claim 1, wherein the connector comprises a chain and a bungie cord.

10. The safety strut device of claim 1, wherein the connector is made of metal.

11. The safety strut device of claim 1, wherein the connector is made of steel.

12. The safety strut device of claim 1, wherein the connector is adjustable.
